(19) United States
(12) Patent Application Publication
(10) Pub. No.: US 2025/0198788 A1
(43) Pub. Date: Jun. 19, 2025

(54) ROUTE-BASED WEATHER CONDITION DISPLAY METHOD AND APPARATUS, COMPUTER DEVICE, AND STORAGE MEDIUM

(71) Applicant: Tencent Technology (Shenzhen) Company Limited, Shenzhen (CN)

(72) Inventors: Liangkun YU, Shenzhen (CN); Jiayin ZHANG, Shenzhen (CN)

(73) Assignee: Tencent Technology (Shenzhen) Company Limited, Shenzhen (CN)

(21) Appl. No.: 19/071,921

(22) Filed: Mar. 6, 2025

Related U.S. Application Data
(63) Continuation of application No. PCT/CN2023/127851, filed on Oct. 30, 2023.

(30) Foreign Application Priority Data
Jan. 17, 2023 (CN) 202310096725.4

(51) Int. Cl. G01C 21/36; G01C 21/00; G06F 3/04817; G06F 3/04847

(52) U.S. Cl. CPC G01C 21/3694; G01C 21/3807; G06F 3/04817; G06F 3/04847

(57) ABSTRACT

A route-based weather condition display method is performed by a computer device. The method includes: determining, based on a start position and an end position, a route from the start position to the end position in response to a route search operation triggered for an electronic map, displaying a target weather icon and the route in the electronic map, the target weather icon indicating a weather condition at a waypoint on the route at a current time, and a first slider being displayed on the route, and playing a plurality of weather icons in the electronic map in response to a sliding operation for the first slider, the plurality of weather icons indicating weather conditions at waypoints on the route corresponding to positions of the first slider at times when the waypoints are passed through.

### CROSS-REFERENCE TO RELATED APPLICATIONS

This application is a continuation application of International Application No. PCT/CN2023/127851 filed on Oct. 30, 2023, which claims priority to Chinese Patent Application No. 202310096725.4, filed with the China National Intellectual Property Administration on Jan. 17, 2023, the disclosures of each being incorporated by reference herein in their entireties.

### FIELD

The disclosure relates to the field of computer technologies, and in particular, to a route-based weather condition display method and apparatus, a computer device, and a storage medium.

### BACKGROUND

With the development of computer technologies, more and more people are accustomed to driving for travel. Before traveling, people usually search for routes through map software on their mobile phones, and then drive along the found route. Since a weather condition is an important factor affecting the travel of people, how to provide the weather condition of each waypoint on the route is a focus of research in the field.

In the related art, a commonly used manner is to provide a search function in the map software, and a weather condition of a city of concern is searched through the function. However, a user needs to actively search for a weather condition of a specific city, making the operation cumbersome and affecting overall efficiency of obtaining the weather condition.

### SUMMARY

Some embodiments provide a route-based weather condition display method, performed by a computer device, the method including: determining, based on a start position and an end position, a route from the start position to the end position in response to a route search operation triggered for an electronic map; displaying a target weather icon and the route in the electronic map, the target weather icon indicating a weather condition at a waypoint on the route at a current time, and a first slider being displayed on the route; and playing a plurality of weather icons in the electronic map in response to a sliding operation for the first slider, the plurality of weather icons indicating weather conditions at waypoints on the route corresponding to positions of the first slider at times when the waypoints are passed through.

Some embodiments provide a route-based weather condition display apparatus, the apparatus including: at least one memory configured to store computer program code; and at least one processor configured to read the program code and operate as instructed by the program code, the program code comprising: determination code configured to cause at least one of the at least one processor to determine, based on a start position and an end position, a route from the start position to the end position in response to a route search operation triggered for an electronic map; and display configured to cause at least one of the at least one processor to: display a target weather icon and the route in the electronic map, the target indicating a weather condition at a waypoint on the route at a current time, and a first slider being displayed on the route; play a plurality of weather icons in the electronic map in response to a sliding operation for the first slider, the plurality of weather icons indicating weather conditions at waypoints on the route corresponding to positions of the first slider at times when the waypoints are passed through.

Some embodiments provide a non-transitory computer-readable storage medium, storing computer code which, when executed by at least one processor, causes the at least one processor to at least: determine, based on a start position and an end position, a route from the start position to the end position in response to a route search operation triggered for an electronic map; display a target weather icon and the route in the electronic map, the target weather icon indicating a weather condition at a waypoint on the route at a current time, and a first slider being displayed on the route; and play a plurality of weather icons in the electronic map in response to a sliding operation for the first slider, the plurality of weather icons indicating weather conditions at waypoints on the route corresponding to positions of the first slider at times when the waypoints are passed through.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment of a route-based weather condition display method according to some embodiments.

FIG. 2 is a flowchart of a route-based weather condition display method according to some embodiments.

FIG. 3 is a flowchart of another route-based weather condition display method according to some embodiments.

FIG. 4 is a schematic diagram of a map area in an electronic map according to some embodiments.

FIG. 5 is a schematic diagram of a map area according to some embodiments.

FIG. 6 is a schematic diagram of a map area in an electronic map according to some embodiments.

FIG. 7 is a schematic diagram of sliding of a second slider according to some embodiments.

FIG. 8 is an interaction flowchart of a route-based weather condition display method according to some embodiments.

FIG. 9 is a block diagram of a route-based weather condition display apparatus according to some embodiments.

FIG. 10 is a block diagram of another route-based weather condition display apparatus according to some embodiments.

FIG. 11 is a structural block diagram of a terminal according to some embodiments.

FIG. 12 is a schematic structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following descriptions, terms such as “first” and “second” are configured for distinguishing between same or similar items with substantially same functions and roles. No logical or temporal dependency exists among the “first”, the “second”, and the “n^{th}”, and a quantity and an execution order are not limited.

In the following descriptions, “at least one” means one or more, and “a plurality of” means two or more.

Information (including but not limited to user device information, user personal information, or the like), data (including but not limited to data configured for analysis, stored data, presented data, or the like), and signals involved in this application are all authorized by a user or fully authorized by various parties, and collection, use, and processing of related data need to comply with relevant laws, regulations, and standards of relevant regions. For example, a start position and an end position involved in this application is obtained under full authorization.

For ease of understanding, terms are explained below.

Route planning: It refers to a result obtained when a user uses a route calculation function of an electronic map to plan a route from a start position to an end position.

Estimated time of arrival (ETA): It refers to an estimated time to reach an end position of a route or a point in the route in a planned route plan.

Weather icon: It refers to a manifestation of a weather condition. The weather icon comes from a satellite cloud image. By displaying a shape characteristic and a movement change of a cloud, a meteorological condition that formed the cloud can be deduced, and a future weather change can be predicted. Generally, the map is configured to display a weather condition such as rainfall, air quality, and wind.

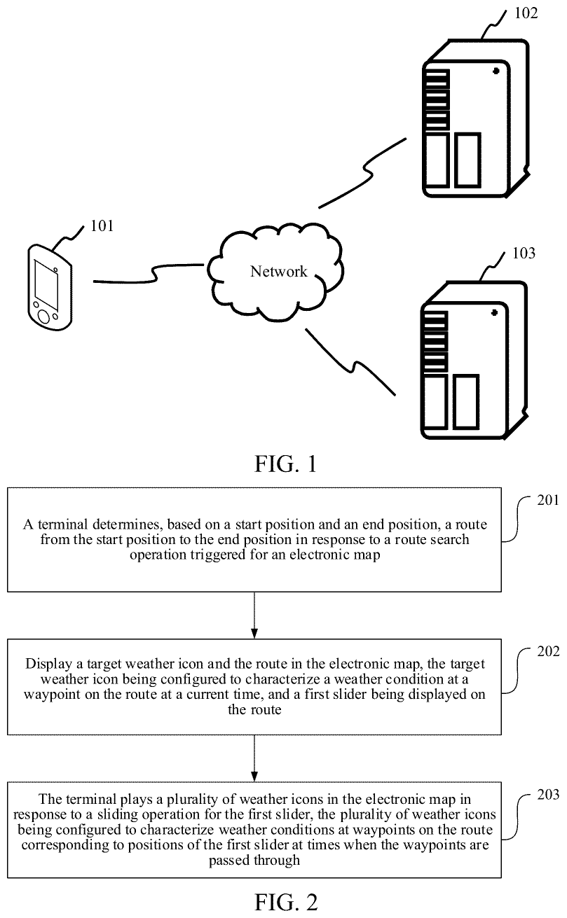

The route-based weather condition display method according to some embodiments can be performed by a computer device. In some embodiments, the computer device may be a terminal or a server. An implementation environment of a route-based weather condition display method according to some embodiments is described first by using an example in which the computer device is a terminal. FIG. 1 is a schematic diagram of an implementation environment of a route-based weather condition display method according to some embodiments. Referring to FIG. 1, the implementation environment includes a terminal 101, a first server 102, and a second server 103. The terminal 101, the first server 102, and the second server 103 may be directly or indirectly connected through wired or wireless communication, which is not limited herein.

In some embodiments, the terminal 101 may be a smart phone, a tablet computer, a notebook computer, a desktop computer, a smart speaker, a smart watch, a smart voice interactive device, a smart household appliance, an on-board terminal, an aircraft, or the like, which is not limited thereto. An application supporting an electronic map is installed and run on the first terminal 101. For example, the terminal 101 is a terminal used by a user. The user can input a start position and an end position of the electronic map installed in the terminal 101. Then, the terminal 101 can plan a route from the start position to the end position for the user. Next, the terminal 101 displays a planned route and a weather icon in the electronic map. The weather icon is configured to characterize a weather condition at a waypoint in a route.

In some embodiments, the first server 102 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence (AI) platform. The first server 102 is configured to provide a background service of planning a route for an application that supports the electronic map. The first server 102 can calculate the route from the start position to the end position based on the start position and the end position transmitted by the terminal 101. Then, the first server 102 transmits the route to the terminal 101. The terminal 101 displays the route in the electronic map.

In some embodiments, the second server 103 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a CDN, big data, and an AI platform. The second server 103 is configured to provide a background service of a weather condition for an application that supports the electronic map. Based on the route transmitted by the first server 102, the second server 103 can provide the first server 102 with a weather icon that can characterize the weather condition at the waypoint on the route. The first server 102 transmits the weather icon to the terminal 101, so that the terminal 101 displays the weather icon in the electronic map.

In some embodiments, the first server 102 and the second server 103 are in charge of primary computing, and the terminal 101 is in charge of secondary computing. In some embodiments, the first server 102 and the second server 103 are in charge of secondary computing, and the terminal 101 is in charge of primary computing. In some embodiments, the terminal 101, the first server 102, and the second server 103 perform collaborative computing by using a distributed computing architecture.

FIG. 2 is a flowchart of a route-based weather condition display method according to some embodiments. Referring to FIG. 2, according to some embodiments a terminal performs the method. The route-based weather condition display method includes the following operations.

201: Determine, based on a start position and an end position, a route from the start position to the end position in response to a route search operation triggered for an electronic map.

In this embodiment of this application, an application supporting the electronic map is installed on a terminal. A user can input the start position and the end position in the electronic map displayed by the application. The terminal obtains the start position and the end position inputted by the user. Then in a case that the route search operation is triggered, the terminal can obtain the route from the start position to the end position based on the start position and the end position. A plurality of routes may be provided, but is not limited thereto.

The route search operation is an operation configured for triggering a search for a route, which may be a click/tap on a button, or may be a somatosensory operation, and may further be a voice control password. The start position is a position configured for determining a starting point of the route, and the end position is a position configured for determining an end point of the route. The start position may be a detected current geographic position, a geographic position inputted into the electronic map, a geographic position recognized from a given text, or a preset geographic position. The end position may be the geographic position inputted into the electronic map, a geographic position predicted by AI, or a preset geographic position.

202: Display a target weather icon and the route in the electronic map, the target weather icon being configured to characterize a weather condition at a waypoint on the route at a current time, and a first slider being displayed on the route.

In this embodiment of this application, the terminal obtains a plurality of weather icons based on the route. The plurality of weather icons are configured to characterize the weather conditions at the waypoints during travel of the user on the route. In other words, the weather icons are configured to characterize a change of the weather condition at the waypoint on the route. The target weather icon is configured to describe a specific weather icon. The plurality of weather icons include the target weather icon. The target weather icon is configured to characterize the weather condition at the waypoint on the route at the current time. The current time is a search moment for the route. The target weather icon is a first weather icon in the plurality of weather icons. The terminal displays the target weather icon and the route in the electronic map. The first slider is displayed on the route. The first slider can slide on the route based on a user operation. The first slider may be set to assume different forms as needed, or may change dynamically based on a preset rule. A time granularity of the change may be at a level of second, minute, hour, day, month, or year. For example, the level of hour may be 1 day or a few days. The target weather icon and route may be displayed in a map area of the electronic map.

203: Play a plurality of weather icons in the electronic map in response to a sliding operation for the first slider, the plurality of weather icons being configured to characterize weather conditions at waypoints on the route corresponding to positions of the first slider at times when the waypoints are passed through.

In this embodiment of this application, in a case that the sliding operation is performed on the first slider, the terminal obtains a position the first slider passes through during sliding. Then the terminal determines, based on the position the first slider passes through, the waypoint on the route corresponding to the position the first slider passes through. Next, the terminal plays, in the map area, the weather icon that can characterize the weather conditions at times when the waypoints are passed through. The plurality of weather icons may be played in the map area of the electronic map.

The embodiments of this application provide a route-based weather condition display method. By triggering the route search operation triggered for the electronic map, the route from the start position to the end position is obtained based on the start position and the end position. Then, the weather icon and the route are displayed in the electronic map. By sliding the first slider on the route, the weather icon changes as the route progresses, and the user can learn a change of weather before traveling, which improves efficiency of obtaining the weather condition, and enhances correlation among the route, the position, and the weather condition, thereby improving user experience.

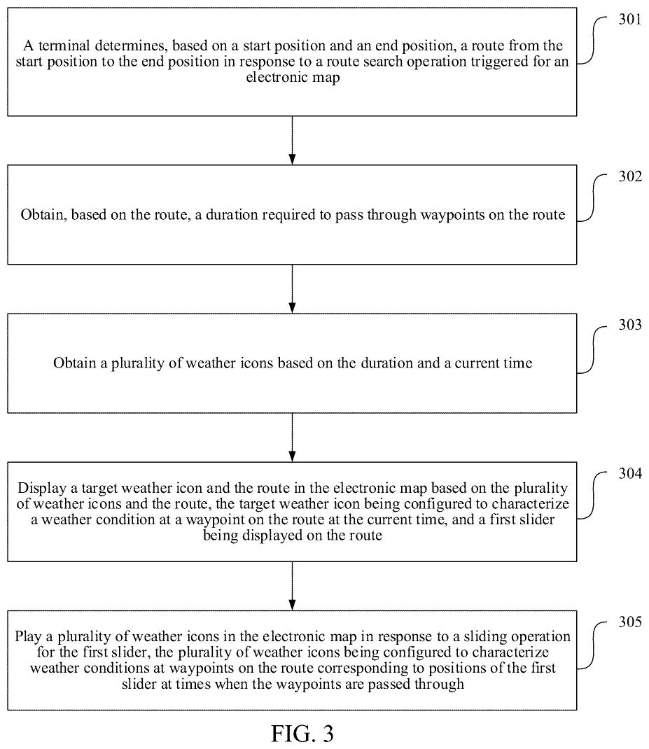

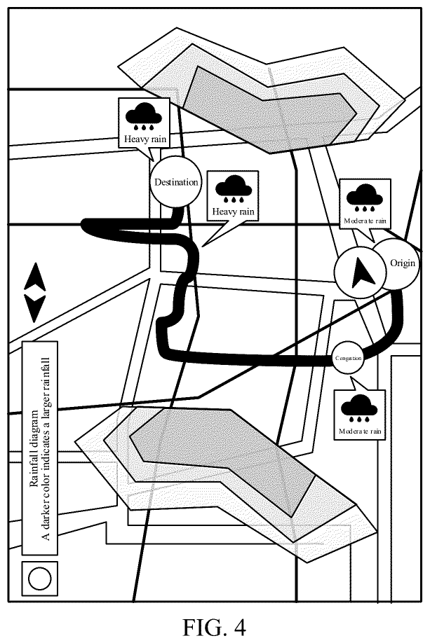

FIG. 3 is a flowchart of another route-based weather condition display method according to some embodiments. Referring to FIG. 3, in this embodiment of this application, a description is provided by using an example in which a terminal performs the method. The route-based weather condition display method includes the following operations.

301: A terminal determines, based on a start position and an end position, a route from the start position to the end position in response to a route search operation triggered for an electronic map.

In some embodiments, the terminal obtains the start position and the end position. For any position in the start position and the end position, a granularity of the position may be a city, a county seat, or an urban area, or the like, but is not limited thereto. The start position may be automatically obtained by the terminal based on a current position, or may be manually inputted by the user, and the like, but is not limited thereto. In some embodiments, an input control is displayed in the electronic map of the terminal. In response to an input operation for the input control, the terminal obtains the start position and the end position.

In a case of triggering the route search operation triggered for the electronic map, the terminal obtains the route from the start position to the end position based on the start position and the end position. In some embodiments, the terminal can transmit a route search request to the first server. The route search request carries the start position and the end position. The first server calculates the route from the start position to the end position based on the start position and the end position. Then, the first server transmits the route to the terminal. The first server is configured to provide a route planning service. The route search request may be referred to as a route calculation request.

302: Obtain, based on the route, a duration required to pass through waypoints on the route.

In some embodiments, the duration required to pass through the route is a duration of an ETA of the route. The duration may be calculated by the first server based on a determined route, or may be calculated by the terminal based on a determined route, but is not limited thereto. The duration may be calculated based on at least one information such as a total distance of the route, a congestion degree at each waypoint on the route, and a traveling mode of the user, but is not limited thereto. The traveling mode may be driving, cycling, or public transportation such as a bus, which is not limited thereto.

303: Obtain a plurality of weather icons based on the duration and a current time.

In some embodiments, the terminal obtains a plurality of weather icons within the duration starting from the current time. The plurality of weather icons are configured to characterize the weather conditions at the waypoints on the route when the waypoints are passed through. Time to pass through different waypoints on the route are different, and corresponding weather icons may be the same or different, which are not limited thereto. The plurality of weather icons may be configured to characterize different types of weather conditions such as rainfall, visibility, or wind at various waypoints on the route, which are not limited thereto. The visibility condition may be determined based on a haze condition or a wind and sand condition, but is not limited thereto. The plurality of weather icons may be provided by a second server. The second server is configured to provide a forecast service for the weather condition.

In some embodiments, the electronic map of the terminal provides a weather condition mode function. Different weather condition modes are configured for obtaining corresponding different types of weather conditions. Based on a current weather condition mode, the terminal can obtain a weather icon configured to characterize a corresponding type of weather condition. Correspondingly, a process of obtaining the plurality of weather icons by the terminal is as follows. The terminal obtains a current weather condition mode, the weather condition mode being configured for characterizing a type of the weather condition. Then, the terminal obtains, based on the weather condition mode, the plurality of weather icons of corresponding types within the duration starting from the current time. According to the solution provided in some embodiments, by obtaining the plurality of weather icons of corresponding types within the duration starting from the current time based on the current weather condition mode, the corresponding type of weather condition can be obtained, which improves flexibility of obtaining the corresponding type of weather condition. In addition, the user can learn about the change of weather before traveling, which improves efficiency of obtaining the weather condition.

The terminal can automatically obtain the weather icon configured to characterize a corresponding type of weather condition, and can also obtain the weather icon of the corresponding type of weather condition based on the type selected by the user, but is not limited thereto. In other words, the terminal can automatically determine the current weather condition mode, and can also determine the current weather condition mode based on the selection of the user, but is not limited thereto.

Manner I: The terminal may determine the current weather condition mode based on the historical weather condition at the waypoint on the route. Correspondingly, a process of obtaining the current weather condition mode by the terminal is as follows. The terminal obtains a historical weather condition at the waypoint on the route based on the route. Then, the terminal determines the current weather condition mode based on the historical weather condition at the waypoint on the route. According to the solution provided in some embodiments, the current weather condition mode is determined based on the historical weather condition at the waypoint on the route, so that a weather icon that meets the historical weather condition at the waypoint can be obtained. Therefore, an obtained weather icon is configured to characterize a change condition of the weather condition at each waypoint of the route more accurately, which increases efficiency and accuracy of obtaining the weather condition, and is more consistent with the requirement of the user, thereby improving user experience.

For example, the historical weather condition in northwest region is windy and sandy. In a case that positions that exceed a target quantity in the waypoint on the route are all located in the northwest region, the terminal can obtain a weather icon configured to characterize visibility. The historical weather condition in southeast region is rainfall. In a case that positions that exceed a target quantity in the waypoint on the route are all located in the southeast region, the terminal can obtain a weather icon configured to characterize a rainfall condition.

Manner II: The terminal may determine the current weather condition mode based on a season to which the current time belongs. Correspondingly, a process of obtaining the current weather condition mode by the terminal is as follows. The terminal obtains the season to which the current time belongs. Then, the terminal determines the current weather condition mode based on the historical weather condition at the waypoint on the route within the season. According to the solution provided in some embodiments, the current weather condition mode is determined based on the historical weather condition at the waypoint on the route within the season to which the current time belongs, so that a weather icon that meets the historical weather condition at the waypoint can be obtained. Therefore, an obtained weather icon is configured to characterize a change condition of the weather condition at each waypoint of the route more accurately, which increases efficiency and accuracy of obtaining the weather condition, and is more consistent with the requirement of the user, thereby improving user experience.

For example, the historical weather condition in various regions during the summer is rainfall. As a result, the terminal can obtain the weather icon configured to characterize the rainfall condition. The historical weather condition in various regions during the autumn is windy. As a result, the terminal can obtain the weather icon configured to characterize the wind condition. The historical weather condition may be a weather condition having a frequency of occurrence meeting a preset condition, for example, the frequency of occurrence is greater than a preset frequency, or a sequence number of the frequency of occurrence among frequencies of occurrence arranged in descending order is less than a preset sequence number (sequence numbers being arranged in ascending order).

Manner III: The electronic map displays a mode selection control. The terminal may determine the current weather condition mode based on a weather condition mode selected by the user. Correspondingly, a process of obtaining the current weather condition mode by the terminal is as follows. The terminal displays a plurality of weather condition modes in response to a triggering operation for the mode selection control. Then, the terminal determines, as a current weather condition mode in response to a selection operation for any weather condition mode, a weather condition mode selected through the selection operation. According to the solution provided in some embodiments, the mode selection control is provided, so that the user can select a weather condition mode of interest from the plurality of weather condition modes by triggering the mode selection control. Therefore, based on the requirement of the user, a weather icon that is configured to characterize a corresponding type of weather condition that the user is concerned about can be provided, which is more consistent with the requirement of the user, improves the user experience, and improves efficiency of obtaining the weather condition. The user can learn the change of weather before traveling.

Manner IV: The electronic map displays a mode change control. The terminal may determine the current weather condition mode based on a weather condition mode changed by the user. Correspondingly, a process of obtaining the current weather condition mode by the terminal is as follows. The terminal displays a plurality of weather condition modes in response to a triggering operation for the mode change control. The plurality of weather condition modes includes the current weather condition mode. Then, the terminal determines, in response to a selection operation for any weather condition mode among the plurality of weather condition modes other than the current weather condition mode, to replace the current weather condition mode with a weather condition mode selected through the selection operation. According to the solution provided in some embodiments, the mode change control is provided, so that the user can change the current weather condition mode by triggering the mode change control. Therefore, based on the requirement of the user, the weather icon that is configured to characterize a corresponding type of weather condition that the user is concerned about can be provided. In addition, weather icons corresponding to a plurality of types of weather conditions can be displayed by switching the plurality of weather condition modes, which is more consistent with the requirement of the user, improves the user experience, and improves efficiency of obtaining the weather condition. The user can learn the change of weather before traveling.

304: Display a target weather icon and the route in the electronic map based on the plurality of weather icons and the route, the target weather icon being configured to characterize a weather condition at a waypoint on the route at the current time, and a first slider being displayed on the route.

In some embodiments, a map is displayed in the map area. In a case that the terminal obtains the plurality of weather icons and the route, the terminal displays each of the weather icons and the route in the map area. The weather icon and the route are displayed on an upper layer of the map. The weather icon may be translucent, but is not limited thereto. The weather icon includes a plurality of colors. The plurality of colors are configured for indicating different degrees of weather conditions. The plurality of colors may include red, green, yellow, and the like, but is not limited thereto.

At least one of a road condition sign and at least one weather bubble may be further displayed on the route, but is not limited in this embodiment of this application. The road condition sign is configured to indicate a road condition of a corresponding position, which may be a plurality of conditions such as congestion, a rear-end collision, a road closure, control, construction, water accumulation, and an obstacle, but is not limited thereto. The weather bubble is configured to characterize a weather condition of the corresponding position.

FIG. 4 is a schematic diagram of a map area in an electronic map according to some embodiments. Referring to FIG. 4, a route and a weather icon are displayed in the map area of the electronic map. In the weather icon, a different position has a different color. It may be seen from the weather icon that weather conditions in different positions are different. FIG. 4 exemplarily shows different precipitation intensities in different positions. Four weather bubbles, one road condition sign, and a first slider are displayed on the route. For any weather bubble, the weather bubble is configured to characterize a precipitation intensity in a corresponding position. The road condition sign “congestion” is configured to characterize a congestion condition in the corresponding position.

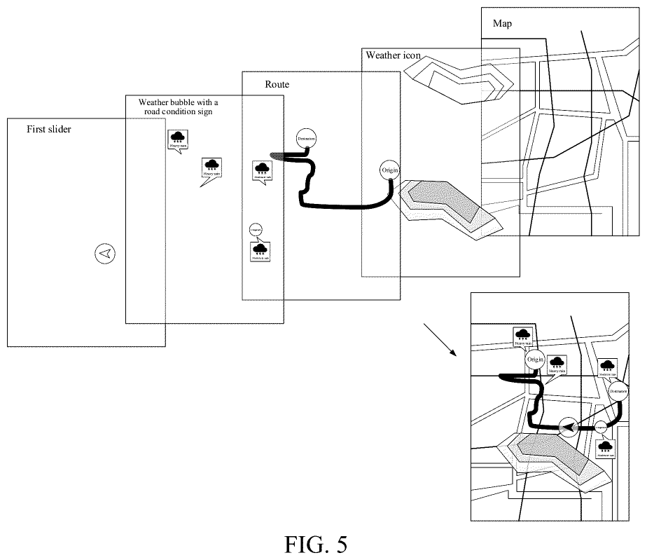

In the map area of the electronic map, the first slider, the weather bubble, the road condition sign, the route, the weather icon, and a display layer where the map is located are different. FIG. 5 is a schematic diagram of a map area according to some embodiments. Referring to FIG. 5, a terminal renders a map at a bottom layer. The terminal renders a weather icon at an upper layer of the map. The terminal renders a route at an upper layer of the weather icon. The terminal renders a weather bubble and a road condition sign on an upper layer of the route. The weather bubble and the road condition sign may be located on the same layer or on different layers, which is not limited thereto. The terminal displays a first slider on the upper layer of the weather bubble and the road condition sign. In this way, the terminal displays a map area in an electronic map.

The foregoing weather bubble may be displayed based on different manners, but is not limited thereto. Five manners of displaying the weather bubble are exemplarily described below.

In a first display manner, the terminal may display the weather bubble at a position where a weather condition meets a condition. Correspondingly, a process of displaying the weather bubble by the terminal is as follows. The terminal obtains at least one target position on a route. A weather condition of the at least one target position meets a target condition. Then the terminal displays a corresponding weather bubble at the at least one target position on the route. The weather bubble is configured to indicate a weather condition of a corresponding position. The target condition may be that a rainfall intensity reaches a moderate rain level, a wind speed reaches level 8, visibility is less than 50 meters, or the like, but is not limited thereto. According to the solution provided in this embodiment of this application, the weather bubble corresponding to the target position is displayed at the at least one target position where the weather condition meets the target condition on the route, so that the weather condition at the target position can be displayed more prominently, and it is convenient for a user to find the weather condition that meets the target condition at the target position, which not only improves efficiency of obtaining the weather condition, but also enhances correlation among the route, the position, and the weather condition, thereby improving user experience.

In a second display manner, the terminal may display the weather bubble in a relatively congested position. Correspondingly, a process of displaying the weather bubble by the terminal is as follows. The terminal obtains at least one target position on a route. A congestion degree of the at least one target position exceeds a target threshold. Then the terminal displays a corresponding weather bubble at the at least one target position on the route. The weather bubble is configured to indicate a weather condition of a corresponding position. A magnitude of the target threshold is not limited in this embodiment of this application. According to the solution provided in this embodiment of this application, since a congestion condition at a waypoint on the route may be related to the weather condition, the weather bubble corresponding to the target position is displayed at the at least one target position where the congestion degree exceeds the target threshold on the route, so that the weather condition at the target position can be displayed more prominently. Therefore, it is convenient for a user to find the weather condition at the target position that is relatively congested, which meets user requirements, and not only improves efficiency of obtaining the weather condition, but also enhances correlation among the route, the position, and the weather condition, thereby improving user experience.

In a third display manner, the terminal may display the weather bubble at a position where a terrain meets a condition. Correspondingly, a process of displaying the weather bubble by the terminal is as follows. The terminal obtains at least one target position on a route. A terrain of the at least one target position is a target terrain. Then the terminal displays a corresponding weather bubble at the at least one target position on the route. The weather bubble is configured to indicate a weather condition of a corresponding position. The target terrain may be a sharp turn, a mountain road, or the like, but is not limited thereto. According to the solution provided in this embodiment of this application, the weather bubble corresponding to the target position is displayed at the at least one target position that meets the target terrain on the route, so that the weather condition at the target position can be displayed more prominently, and it is convenient for a user to find the weather condition at the target terrain and convenient for the user to adjust a travel strategy based on the weather condition of the target terrain, such as changing a route or adjusting a travel speed, which not only improves efficiency of obtaining the weather condition, but also enhances correlation among the route, the position, and the weather condition, thereby improving user experience.

In a fourth display manner, the terminal may display the weather bubble at a position where a service is provided. Correspondingly, a process of displaying the weather bubble by the terminal is as follows. The terminal obtains at least one target position on a route. The at least one target position is configured for providing a service. Then the terminal displays a corresponding weather bubble at the at least one target position on the route. The weather bubble is configured to indicate a weather condition of a corresponding position. The target position may be a service area, a gas station, a charging station, or the like, but is not limited thereto. According to the solution provided in this embodiment of this application, the weather bubble corresponding to the target position is displayed at the at least one target position that provides the service on the route, so that the weather condition at the target position can be displayed more prominently, and it is convenient for a user to find the weather condition at the position where the service is provided, and convenient for the user to adjust a travel strategy based on the weather condition at the position where the service is provided on the route, such as extending or shortening a parking duration at the position where the service is provided, which not only improves efficiency of obtaining the weather condition, but also enhances correlation among the route, the position, and the weather condition, thereby improving user experience.

In a fifth display manner, the terminal may further display the weather bubble based on a time each position is passed on the route. Correspondingly, a process of displaying the weather bubble by the terminal is as follows. The terminal obtains the time corresponding to each position on the route. Then the terminal displays a weather bubble at a preset time interval based on the time corresponding to each position on the route. According to the solution provided in this embodiment of this application, the weather bubble is displayed at the preset time interval on the route based on the time corresponding to each position on the route, so that a weather condition that the user is to experience at the preset time interval in future can be displayed more prominently, which not only improves efficiency of obtaining the weather condition, but also enhances correlation among the route, the position, and the weather condition, thereby improving user experience.

The terminal can also update the foregoing weather icon. In some embodiments, a mode change control is displayed in the electronic map. The terminal may update the weather icon and display an updated weather icon based on the weather condition mode changed by the user. The terminal displays a plurality of weather condition modes in response to a triggering operation for the mode change control. Then, the terminal determines, in response to a selection operation for any weather condition mode among the plurality of weather condition modes other than the current weather condition mode, to replace the current weather condition mode with a weather condition mode selected through the selection operation. Then, the terminal updates the weather icon and displays an updated weather icon in the electronic map based on the replaced weather condition mode. According to the solution provided in this embodiment of this application, the mode change control is provided, so that the user can change the current weather condition mode by triggering the mode change control. Therefore, based on the requirement of the user, the weather icon that is configured to characterize a corresponding type of weather condition that the user is concerned about can be provided. In addition, weather icons corresponding to a plurality of types of weather conditions can be displayed by switching the plurality of weather condition modes, which is more consistent with the requirement of the user, improves the user experience, and improves efficiency of obtaining the weather condition. The user can learn the change of weather before traveling.

The terminal may further automatically update the weather icon if the weather condition changes. In some embodiments, the terminal may periodically obtain the route and the weather icon. In other words, the terminal may periodically transmit a route search request to the first server. In a case that the route changes, the first server requests a new weather icon from the second server based on a new route. Then, the first server transmits the new route and the new weather icon to the terminal. Next, the terminal updates the weather icon and the route and displays an updated weather icon and an updated route in the map area. In some embodiments, in a case that the weather condition changes, the first server requests the new weather icon from the second server based on an original route. Then, the first server transmits the new weather icon to the terminal. Next, the terminal updates the weather icon and displays an updated weather icon in the map area. The terminal may further update a weather bubble and displays an updated weather bubble.

In some embodiments, in a case that the route or the weather icon changes, the terminal may further automatically receive a new route or a new weather icon transmitted by the first server. In other words, in a case that the route changes, the first server requests a new weather icon from the second server based on a new route. Then, the first server transmits the new route and the new weather icon to the terminal. The terminal updates the weather icon and the route and displays an updated weather icon and an updated route in the map area, and updates the process line and displays an updated process line in the map area. In a case that the weather condition changes, the second server transmits the new weather icon to the first server, and the first server transmits the new weather icon to the terminal. Next, the terminal updates the weather icon and displays an updated weather icon in the map area. In the manner, the terminal does not need to transmit a request to the first server. In this embodiment of this application, the manner in which the terminal updates the weather icon and displays an updated weather icon is not limited.

The terminal may further display the process line in the electronic map. Two ends of the process line respectively correspond to a start position and an end position on the route. The process line is configured to characterize a traveling progress of the user on the route. The process line may be displayed in the map area or in the map area other than the map area, but is not limited thereto. The map area may be displayed on an upper layer of the map area, or may be displayed in the electronic map side by side with the map area. In this embodiment of this application, a positional relationship between the map area and the map area is not limited.

The terminal may render a straight line in the electronic map with a whole distance of the route as a total length and a length as a base unit. The terminal may further render a straight line in the electronic map with an entire duration of the route as a total length and a time as a base unit, but is not limited thereto. The straight line is the process line. The process line may be a horizontal line or a vertical line, but is not limited thereto. The process line may be referred to as an earthworm line. A plurality of colors may be displayed in the process line. The plurality of colors are configured for indicating a congestion condition of a corresponding position. The plurality of colors may include red, green, yellow, and the like, but is not limited thereto. The second slider may be displayed on the process line. The second slider can slide on the process line based on a user operation, to characterize waypoints on the route the user passes through. The terminal simultaneously displays the route, the weather icon, and process line, so that users can obtain the weather condition at each waypoint on the route, which strengthens correlation among the route, the position, and the weather condition, thereby improving user experience.

The process line may further display at least one of the time, the road condition sign, and at least one weather bubble, but is not limited thereto. The time is configured to indicate an expected arrival time at a corresponding position. The time may be a duration it takes to reach a corresponding position, such as 1 hour or 2 hours. The time may also be a specific moment to arrive at a corresponding position, such as 21:58, but is not limited thereto.

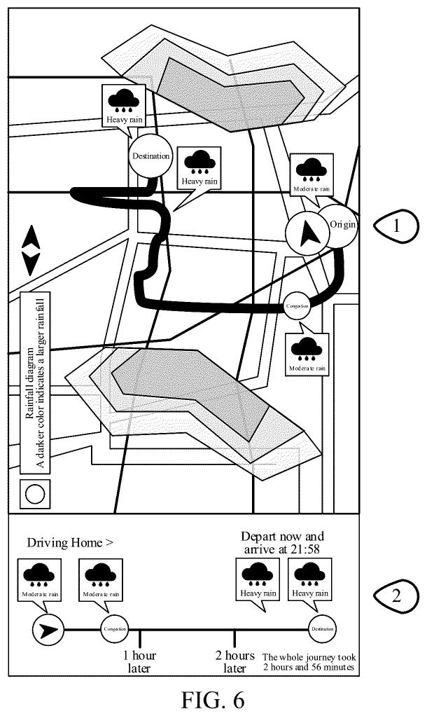

FIG. 6 is a schematic diagram of a map area in an electronic map according to some embodiments. Referring to FIG. 6, a first part of the electronic map is the map area. A route and a weather icon are displayed in the map area. In the weather icon, a different position has a different color. It may be seen from the weather icon that weather conditions in different positions are different. FIG. 6 exemplarily shows different precipitation intensities in different positions. Four weather bubbles, one road condition sign, and a second slider are displayed on the route. For any weather bubble, the weather bubble is configured to characterize a precipitation intensity in a corresponding position. The road condition sign “congestion” is configured to characterize a congestion condition in the corresponding position. A second part of the electronic map is the map area. A process line is displayed in the map area. As with the route, four weather bubbles, one road condition sign, and a first slider are displayed on the process line. A timeline is further displayed on the process line. The timeline is annotated with a current time “now”, “1 hour later”, “2 hours later”, and a total duration spent on the entire route “2 hours and 56 minutes”.

305: Play a plurality of weather icons in the electronic map in response to a sliding operation for the first slider, the plurality of weather icons being configured to characterize weather conditions at waypoints on the route corresponding to positions of the first slider at times when the waypoints are passed through.

In this embodiment of this application, in a case that the sliding operation is performed on the first slider, the terminal determines, based on the position the first slider passes through, the waypoint on the route corresponding to the position the first slider passes through. Next, the terminal plays, in the map area, the weather icon that can characterize a weather condition at each waypoint at times when the waypoints are passed through. Correspondingly, the terminal obtains, in response to a sliding operation for the first slider, a plurality of positions the first slider passes through on the process line. Then, the terminal obtains a plurality of expected times of arrival at the plurality of positions. Next, the terminal successively displays a weather icon corresponding to each of the plurality of times in the map area. According to the solution provided in this embodiment of this application, in a case that the first slider is slid, the plurality of expected times of arrival at the plurality of positions are determined based on the plurality of positions the first slider passes through on the process line. Then, the weather icons corresponding to each of the plurality of times are successively displayed, so that a change in the weather condition at each waypoint on the route can be dynamically displayed as the user travels. Therefore, the user can learn a change of weather before traveling, which improves efficiency of obtaining the weather condition, and enhances correlation among the route, the position, and the weather condition, thereby improving user experience.

In some embodiments, a plurality of positions may further be stored in the terminal. The plurality of positions are successively arranged based on an order of passing through on the route. In a case that the first slider is slid on the route, the terminal determines the position of the first slider after sliding. Then, the terminal uses a position before the position as the waypoint corresponding to the position the first slider passes through. Next, the terminal plays, in the map area, the weather icon that can characterize a weather condition at each waypoint at times when the waypoints are passed through. A manner of determining the waypoint corresponding to the first slider is not limited in this embodiment of this application.

The foregoing first slider may slide in response to triggering of an operation performed by the user on the first slider, or may slide in response to the sliding of the second slider on the process line, but is not limited thereto.

In some embodiments, the first slider slides in response to sliding of the second slider on the process line. The second slider is displayed on the process line. The second slider corresponds to the first slider. The first slider can slide as the second slider slides. Correspondingly, the terminal displays, in response to a sliding operation for the second slider, that the first slider slides on the route based on a plurality of positions the second slider passes through on the process line. A position the first slider passes through on the route corresponds to a position the second slider passes through. According to the solution provided in this embodiment of this application, the second slider is displayed on the process line, and the second slider is caused to correspond to the first slider, so that when the second slider is slid on the process line, the first slider also correspondingly slides on the route in the map area, which enriches a manner of sliding the first slider on the route. Since the position of the second slider on the process line corresponds to the position of the first slider on the route at all times, a travel process of the user on the route can be characterized by sliding the second slider, thereby improving user experience.

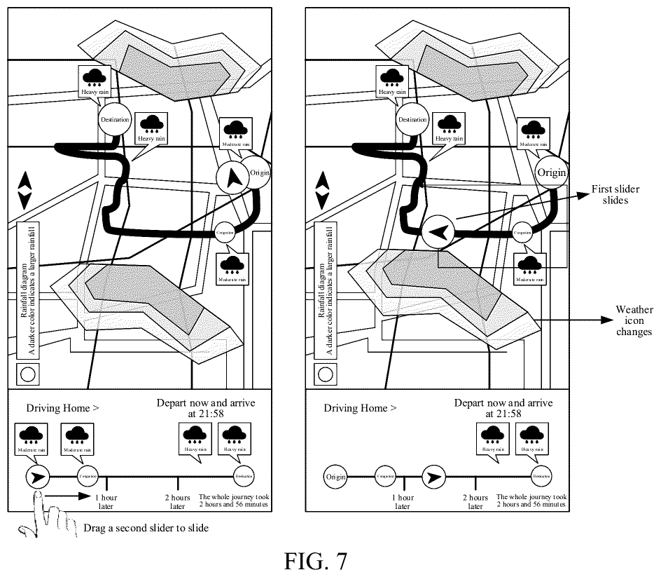

FIG. 7 is a schematic diagram of sliding of a second slider according to some embodiments. (a) in FIG. 7 exemplarily shows a weather icon, a route, and a process line displayed by a terminal before a second slider is slid. When the second slider is not slid, the second slider is displayed at a head end of the process line. The head end is configured for indicating a start position on the route. The first slider is displayed at the start position on the route. The terminal displays a target weather icon in a map area. The target weather icon is configured to characterize a weather condition at a waypoint on the route at a current time. A user can drag the second slider, so that the second slider slides on the process line. The terminal displays, in the map area in response to a sliding operation for the second slider, a weather icon that can characterize a weather condition at a waypoint corresponding to a position the second slider passes through. (b) in FIG. 7 exemplarily shows a weather icon, a route, and a process line displayed by a terminal after the second slider is slid. It may be seen from (b) in FIG. 7 that the weather icon in the map area changes. In other words, a rainfall intensity of each waypoint changes. The first slider on the route in the map area also slides with the second slider.

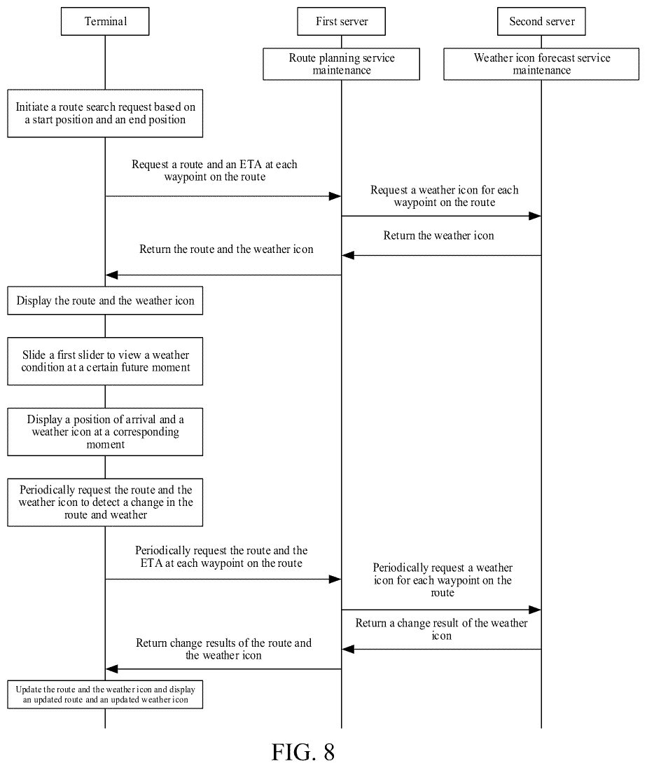

To describe the route-based weather condition display method according to some embodiments more clearly, the method is described again below in conjunction with the accompanying drawings. FIG. 8 is an interaction flowchart of a route-based weather condition display method according to some embodiments. Referring to FIG. 8, the first server is configured to provide a route planning service. The second server is configured to provide a forecast service for a weather icon. The terminal can initiate a route search request based on a start position and an end position. The terminal requests a route and an ETA at each waypoint on the route from the first server. Then, the first server can request a weather icon configured to characterize the weather condition at each waypoint when passing through the waypoint on the route from the second server. Then, the second server returns the weather icon to the first server. The first server returns the route to the terminal along with the weather icon. Next, the terminal displays the target weather icon and the route in the electronic map of the route, and displays the process line in the map area of the electronic map. A first slider is displayed on the route. The second slider is displayed on the process line. By sliding the second slider, the user can view a weather condition at a certain future moment during the route. Then, in a case that the second slider is slid, the terminal displays a weather condition of the first slider that slides with the second slider and a waypoint corresponding to a position of the second slider. Then, the terminal may periodically request the route and the weather icon, to detect a change in the route and weather. In other words, the terminal periodically requests the route and the ETA at each waypoint on the route from the first server. The first server periodically requests a weather icon for each waypoint on the route from the second server. Then, the second server returns a change result of the weather icon to the first server. The first server returns the route to the terminal with the change result of the weather icon. Next, the terminal updates the weather icon and the route and displays an updated weather icon and an updated route in the map area of the electronic map of the route.

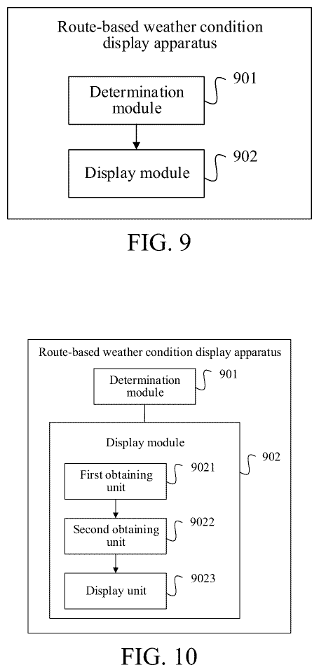

FIG. 9 is a block diagram of a route-based weather condition display apparatus according to some embodiments. The apparatus is configured to perform the operations during execution of the foregoing route-based weather condition display method. Referring to FIG. 9, the route-based weather condition display apparatus includes a determination module 901 and a display module 902.

The determination module 901 is configured to determine, based on a start position and an end position, a route from the start position to the end position in response to a route search operation triggered for an electronic map.

The display module 902 is configured to display a target weather icon and the route in the electronic map, the target weather icon being configured to characterize a weather condition at a waypoint on the route at a current time, and a first slider being displayed on the route.

The display module 902 is further configured to play a plurality of weather icons in the electronic map in response to a sliding operation for the first slider, the plurality of weather icons being configured to characterize weather conditions at waypoints on the route corresponding to positions of the first slider at times when the waypoints are passed through.

Some embodiments provide a route-based weather condition display apparatus. By triggering the route search operation triggered for the electronic map, the route from the start position to the end position is obtained based on the start position and the end position. Then, the weather icon and the route are displayed in the electronic map. By sliding the first slider on the route, the weather icon changes as the route progresses, and the user can learn a change of weather before traveling, which improves efficiency of obtaining the weather condition, and enhances correlation among the route, the position, and the weather condition, thereby improving user experience.

In some embodiments, FIG. 10 is a block diagram of another route-based weather condition display apparatus according to some embodiments. Referring to FIG. 10, the display module 902 includes:
a first obtaining unit 9021, configured to obtain, based on the route, a duration required to pass through waypoints on the route;
a second obtaining unit 9022, configured to obtain a plurality of weather icons based on the duration and a current time; and
a display unit 9023, configured to display a target weather icon and the route in an electronic map based on the plurality of weather icons and the route and display a process line in a map area of the electronic map.

In some embodiments, still referring to FIG. 10, the second obtaining unit 9022 is configured to: obtain a current weather condition mode, the weather condition mode being configured for characterizing a type of the weather condition; and obtain, based on the weather condition mode, the plurality of weather icons of corresponding types within the duration starting from the current time.

In some embodiments, still referring to FIG. 10, the second obtaining unit 9022 is configured to: obtain a historical weather condition at the waypoint on the route based on the route; and determine the current weather condition mode based on the historical weather condition at the waypoint on the route.

In some embodiments, still referring to FIG. 10, a mode selection control is displayed in the electronic map.

The display module 902 is further configured to: display a plurality of weather condition modes in response to a triggering operation for the mode selection control; and determine, as a current weather condition mode in response to a selection operation for any weather condition mode, a weather condition mode selected through the selection operation.

In some embodiments, still referring to FIG. 10, a mode change control is displayed in the electronic map.

The display module 902 is further configured to: display a plurality of weather condition modes in response to a triggering operation for the mode change control, the plurality of weather condition modes including the current weather condition mode; determine, in response to a selection operation for any weather condition mode among the plurality of weather condition modes other than the current weather condition mode, to replace the current weather condition mode with a weather condition mode selected through the selection operation; and update the weather icon and display an updated weather icon in the electronic map based on the replaced weather condition mode.

In some embodiments, still referring to FIG. 10, the display module 902 is configured to: obtain, in response to a sliding operation for a first slider, a plurality of positions the first slider passes through on the route; obtain a plurality of expected times of arrival at the plurality of positions; and successively display a weather icon corresponding to each of the plurality of times in the map area.

In some embodiments, still referring to FIG. 10, the display module 902 is further configured to: obtain at least one target position on the route, a weather condition of the at least one target position meeting a target condition; and display a corresponding weather bubble at the at least one target position on the route, the weather bubble being configured to indicate a weather condition at a corresponding position.

In some embodiments, still referring to FIG. 10, the display module 902 is further configured to: obtain at least one target position on the route, a congestion degree of the at least one target position exceeding a target threshold; and display a corresponding weather bubble at the at least one target position on the route, the weather bubble being configured to indicate a weather condition at a corresponding position.

In some embodiments, still referring to FIG. 10, the display module 902 is further configured to: obtain at least one target position on the route, a terrain of the at least one target position being a target terrain; and display a corresponding weather bubble at the at least one target position on the route, the weather bubble being configured to indicate a weather condition at a corresponding position.

In some embodiments, still referring to FIG. 10, the display module 902 is further configured to: obtain at least one target position on the route, the at least one target position being configured for providing a service; and display a corresponding weather bubble at the at least one target position on the route, the weather bubble being configured to indicate a weather condition at a corresponding position.

In some embodiments, still referring to FIG. 10, the display module 902 is further configured to: display a process line in the electronic map, two ends of the process line respectively corresponding to the start position and the end position, a second slider being displayed on the process line, the second slider corresponding to the first slider; and display, in response to a sliding operation for the second slider based on a plurality of positions the second slider passes through on the process line, that the first slider slides on the route, a position the first slider passes through on the route corresponding to a position the second slider passes through.

The route-based weather condition display apparatus provided in the foregoing embodiment is illustrated only with an example of division of the foregoing function modules when displaying the weather condition of each waypoint on the route. In practical applications, the foregoing functions may be allocated to and completed by different function modules as required. To be specific, the internal structure of the apparatus is divided into different function modules to complete all or some of the functions described above. In addition, the route-based weather condition display apparatus provided in the foregoing embodiments and the embodiment of the route-based weather condition display method belong to the same concept. For details of a specific implementation process, reference may be made to the method embodiments. Details are not described herein again.

According to some embodiments, each module in the apparatus may exist respectively or be combined into one or more units. Certain (or some) unit in the units may be further split into multiple smaller function subunits, thereby implementing the same operations without affecting the technical effects of some embodiments. The modules are divided based on logical functions. In actual applications, a function of one module may be realized by multiple units, or functions of multiple modules may be realized by one unit. In some embodiments, the apparatus may further include other units. In actual applications, these functions may also be realized cooperatively by the other units, and may be realized cooperatively by multiple units.

A person skilled in the art would understand that these “modules” and “units” could be implemented by hardware logic, a processor or processors executing computer software code, or a combination of both. The “modules” and “units” may also be implemented in software stored in a memory of a computer or a non-transitory computer-readable medium, where the instructions of each module and unit are executable by a processor to thereby cause the processor to perform the respective operations of the corresponding module and unit.

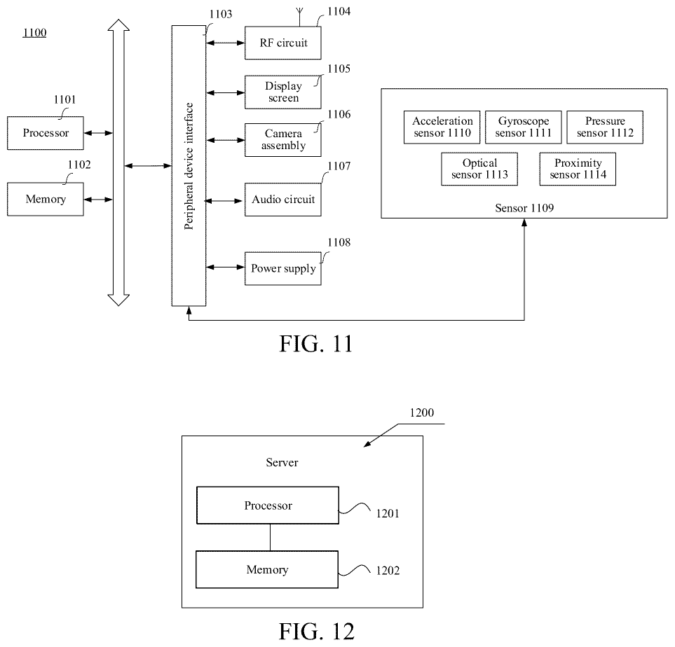

FIG. 11 is a structural block diagram of a terminal 1100 according to some embodiments. The terminal 1100 may be a portable mobile terminal, such as a smartphone, a tablet computer, a moving picture experts group audio layer III (MP3) player, a moving picture experts group audio layer IV (MP4) player, a notebook computer, a desktop computer, a smart speaker, a smart watch, a smart voice interactive device, a smart household appliance, an on-board terminal, an aircraft, or the like. The terminal 1100 may also be referred to as another name such as user device, a portable terminal, a laptop terminal, or a desktop terminal.

Generally, the terminal 1100 includes a processor 1101 and a memory 1102.

The processor 1101 may include one or more processing cores, for example, a 4-core processor or an 8-core processor. The processor 1101 may be implemented in at least one hardware form of a digital signal processor (DSP), a field-programmable gate array (FPGA), and a programmable logic array (PLA). The processor 1101 may include a main processor and a coprocessor. The main processor is configured to process data in a wake-up state, which is also referred to as a central processing unit (CPU). The coprocessor is a low-power processor configured to process data in a standby mode. In some embodiments, the processor 1101 may have a graphics processing unit (GPU) integrated therein. The GPU is configured to render and draw content that needs to be displayed on a display screen. In some embodiments, the processor 1101 may further include an AI processor. The AI processor is configured to process computing operations related to machine learning.

The memory 1102 may include one or more computer-readable storage media. The computer-readable storage medium may be non-transient. The memory 1102 may further include a high-speed random access memory and a non-volatile memory, such as one or more disk storage devices or flash storage devices. In some embodiments, a non-transitory computer-readable storage medium in the memory 1102 is configured to store at least one computer program. The at least one computer program is configured to be executed by the processor 1101, to implement the route-based weather condition display method provided in the method embodiments of this application.

In some embodiments, the terminal 1100 may include a peripheral device interface 1103 and at least one peripheral device. The processor 1101, the memory 1102, and the peripheral device interface 1103 may be connected through a bus or a signal cable. Each peripheral device may be connected to the peripheral device interface 1103 by a bus, a signal line, or a circuit board. For example, the peripheral device includes at least one of a radio frequency (RF) circuit 1104, a display screen 1105, a camera assembly 1106, an audio circuit 1107, and a power supply 1108.

The peripheral device interface 1103 may be configured to connect at least one input/output (I/O)-related peripheral device to the processor 1101 and the memory 1102. In some embodiments, the processor 1101, the memory 1102, and the peripheral device interface 1103 are integrated on the same chip or circuit board. In some other embodiments, any one or two of the processor 1101, the memory 1102, and the peripheral device interface 1103 may be implemented on an independent chip or circuit board, but is not limited thereto.

The RF circuit 1104 is configured to receive and transmit an RF signal, which is also referred to as an electromagnetic signal. The RF circuit 1104 communicates with a communication network and another communication device through the electromagnetic signal. The RF circuit 1104 converts an electric signal into an electromagnetic signal for transmission, or converts a received electromagnetic signal into an electric signal. In some embodiments, the RF circuit 1104 includes an antenna system, an RF transceiver, one or more amplifiers, a tuner, an oscillator, a digital signal processor, a codec chip set, a subscriber identity module card, and the like. The RF circuit 1104 may communicate with the another terminal through at least one wireless communication protocol. The wireless communication protocol includes but is not limited to a World Wide Web, a metropolitan area network, Intranet, various generations of mobile communication networks (2G, 3G, 4G, and 5G), a wireless local area network, and/or a wireless fidelity (Wi-Fi) network. In some embodiments, the RF circuit 1104 may further include a near field communication (NFC)-related circuit, which is not limited herein.

The display screen 1105 is configured to display a user interface (UI). The UI may include a graph, text, an icon, a video, and any combination thereof. When the display screen 1105 is a touch display screen, the display screen 1105 further has a capability of acquiring a touch signal on or above a surface of the display screen 1105. The touch signal may be inputted to the processor 1101 as a control signal for processing. In this case, the display screen 1105 may be further configured to provide a virtual button and/or a virtual keyboard, which are/is also referred to as a soft button and/or a soft keyboard. In some embodiments, one display screen 1105 may be arranged on a front panel of the terminal 1100. In some other embodiments, at least two display screens 1105 may be respectively arranged on different surfaces of the terminal 1100 or may be folded. In still other embodiments, the display screen 1105 may be a flexible display screen arranged on a curved surface or a folded surface of the terminal 1100. Even, the display screen 1105 may be further set in a non-rectangular irregular pattern, namely, a special-shaped screen. The display screen 1105 may be manufactured by using materials such as a liquid crystal display (LCD) or an organic light-emitting diode (OLED).

The camera assembly 1106 is configured to acquire an image or a video. In some embodiments, the camera assembly 1106 includes a front camera and a rear camera. Generally, the front camera is arranged on the front panel of the terminal, and the rear camera is arranged on the back of the terminal. In some embodiments, at least two rear cameras are arranged, which are respectively any of a main camera, a depth-of-field camera, a wide-angle camera, and a telephoto camera, to achieve background blurring through fusion of the main camera and the depth-of-field camera, panoramic photographing and virtual reality (VR) photographing through fusion of the main camera and the wide-angle camera, or another fusion photographing function. In some embodiments, the camera assembly 1106 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1107 may include a microphone and a speaker. The microphone is configured to acquire sound waves of a user and an environment, and convert the sound wave into an electrical signal to input to the processor 1101 for processing, or input to the RF circuit 1104 for implementing voice communication. For the purpose of stereo acquisition or noise reduction, a plurality of microphones may be respectively arranged at different parts of the terminal 1100. The microphone may be further an array microphone or an omnidirectional acquisition microphone. The speaker is configured to convert the electrical signal from the processor 1101 or the RF circuit 1104 into sound waves. The speaker may be a conventional film speaker, or may be a piezoelectric ceramic speaker. When the speaker is the piezoelectric ceramic speaker, the speaker can not only convert an electric signal into a sound wave audible to human beings, but also convert the electric signal into a sound wave inaudible to human beings for ranging and the like. In some embodiments, the audio circuit 1107 may further include an earphone jack.

The power supply 1108 is configured to supply power to components in the terminal 1100. The power supply 1108 may be an alternating current battery, a direct current battery, a disposable battery, or a rechargeable battery. When the power supply 1108 includes a rechargeable battery, and the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may be further configured to support a fast charging technology.

In some embodiments, the terminal 1100 further includes one or more sensors 1109. The one or more sensors 1109 include but are not limited to an acceleration sensor 1110, a gyroscope sensor 1111, a pressure sensor 1112, an optical sensor 1113, and a proximity sensor 1114.

The acceleration sensor 1110 may detect a magnitude of acceleration on three coordinate axes of a coordinate system established by using the terminal 1100. For example, the acceleration sensor 1110 may be configured to detect components of gravity acceleration on the three coordinate axes. The processor 1111 may control, based on a gravity acceleration signal collected by the acceleration sensor 1110, the display screen 1105 to display the UI in a landscape view or a portrait view. The acceleration sensor 1110 may be further configured to acquire motion data of a game or a user.

The gyroscope sensor 1111 may detect a body direction and a rotation angle of the terminal 1100. The gyroscope sensor 1111 may cooperate with the acceleration sensor 1110 to acquire a 3D action by the user on the terminal 1100. The processor 1111 may implement the following functions based on the data acquired by the gyroscope sensor 1111: movement sensing (for example, changing the UI based on a tilt operation of the user), image stabilization during shooting, game control, and inertial navigation.

The pressure sensor 1112 may be arranged at a side frame of the terminal 1100 and/or a lower layer of the display screen 1105. When the pressure sensor 1112 is arranged at the side frame of the terminal 1100, a holding signal of the user on the terminal 1100 may be detected. The processor 1111 performs left/right hand recognition or a quick operation based on the holding signal acquired by the pressure sensor 1112. When the pressure sensor 1112 is arranged on the lower layer of the display screen 1105, the processor 1111 controls, based on a pressure operation of the user on the display screen 1105, an operable control on the UI. The operable control includes at least one of a button control, a scroll-bar control, an icon control, and a menu control.

The optical sensor 1113 is configured to acquire ambient light intensity. In an embodiment, the processor 1111 may control display brightness of the display screen 1105 based on the ambient light intensity collected by the optical sensor 1113. For example, when the ambient light intensity is relatively high, the display brightness of the display screen 1105 is increased. When the ambient light intensity is relatively low, the display brightness of the display screen 1105 is reduced. In another embodiment, the processor 1111 may further dynamically adjust a camera parameter of the camera assembly 1106 based on the ambient light intensity acquired by the optical sensor 1113.

The proximity sensor 1114, also referred to as a distance sensor, is generally arranged on the front panel of the terminal 1100. The proximity sensor 1114 is configured to acquire a distance between a user and a front surface of the terminal 1100. In an embodiment, when the proximity sensor 1114 detects that the distance between the user and the front of the terminal 1100 is gradually smaller, the processor 1111 controls the display screen 1105 to switch from a screen-on state to a screen-off state. When the proximity sensor 1114 detects that the distance between the user and the front surface of the terminal 1100 gradually increases, the display screen 1105 is controlled by the processor 1111 to switch from the screen-off state to the screen-on state.

A person skilled in the art may understand that the structure shown in FIG. 11 does not constitute a limitation on the terminal 1100. The terminal may include more or fewer components than those shown in the figure, or some merged components, or different component arrangements.

FIG. 12 is a schematic structural diagram of a server according to some embodiments. The server may be a first server or a second server. A server 1200 may vary considerably depending on configuration or performance, and may include one or more central processing units (CPU) 1201 and one or more memories 1202. Each memory 1202 has at least one computer-readable instruction stored therein. The at least one computer-readable instruction is loaded and executed by the processor 1201, to implement the route-based weather condition display method provided in the above method embodiments. Certainly, the server may further have components such as a wired or wireless network interface, a keyboard, and an I/O interface, to perform input and output. The server may further include another component configured to implement a device function. Details are not described herein.

Some embodiments further provide a computer-readable storage medium, having at least one computer-readable instruction stored therein, the at least one computer-readable instruction being loaded and executed by a processor of a terminal, to implement the operations of the route-based weather condition display method provided in the above embodiments. For example, the computer-readable storage medium may be a read-only memory (ROM), a random access memory (RAM), a compact disc read-only memory (CD-ROM), a magnetic tape, a floppy disk, an optical data storage device, or the like.

Some embodiments further provide a computer program product, including a computer-readable instruction, the computer-readable instruction being stored in a computer-readable storage medium. A processor of a computer device reads the computer-readable instruction from the computer-readable storage medium, and the processor executes the computer-readable instruction, to cause the computer device to perform the route-based weather condition display method provided in the above optional implementations.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A route-based weather condition display method, performed by a computer device, comprising:
determining, based on a start position and an end position, a route from the start position to the end position in response to a route search operation triggered for an electronic map;
displaying a target weather icon and the route in the electronic map, the target weather icon indicating a weather condition at a waypoint on the route at a current time, and a first slider being displayed on the route; and
playing a plurality of weather icons in the electronic map in response to a sliding operation for the first slider, the plurality of weather icons indicating weather conditions at waypoints on the route corresponding to positions of the first slider at times when the waypoints are passed through.

2. The route-based weather condition display method according to claim 1, wherein the target weather icon and the route are displayed in a map area of the electronic map, and the plurality of weather icons are played in the map area of the electronic map.

3. The route-based weather condition display method according to claim 1, wherein the displaying comprises:
obtaining, based on the route, a duration required to pass through the waypoints on the route;
obtaining the plurality of weather icons based on the duration and the current time; and
displaying the target weather icon and the route in the electronic map based on the plurality of weather icons and the route.

4. The route-based weather condition display method according to claim 3, wherein the obtaining the plurality of weather icons comprises:
obtaining a current weather condition mode, the weather condition mode characterizing a type of the weather condition; and
obtaining, based on the weather condition mode, the plurality of weather icons of corresponding types within the duration starting from the current time.

5. The route-based weather condition display method according to claim 4, wherein the obtaining a current weather condition mode comprises:
obtaining a historical weather condition at the waypoint on the route based on the route; and
determining the current weather condition mode based on the historical weather condition at the waypoint on the route.

6. The route-based weather condition display method according to claim 4, further comprising:
displaying a mode selection control in the electronic map;
displaying a plurality of weather condition modes in response to a triggering operation for the mode selection control; and
determining, as a current weather condition mode in response to a selection operation for any weather condition mode, a weather condition mode selected through the selection operation.

7. The route-based weather condition display method according to claim 4, further comprising:
displaying a mode change control in the electronic map;
displaying a plurality of weather condition modes in response to a triggering operation for the mode change control, the plurality of weather condition modes comprising the current weather condition mode;
determining, in response to a selection operation for any weather condition mode among the plurality of weather condition modes other than the current weather condition mode, to replace the current weather condition mode with the weather condition mode selected through the selection operation; and
updating the weather icon and displaying an updated weather icon in the electronic map based on the replaced weather condition mode.

8. The route-based weather condition display method according to claim 1, wherein the playing the plurality of weather icons comprises:
obtaining, in response to the sliding operation for the first slider, a plurality of positions that the first slider passes through on the route;
obtaining a plurality of expected times of arrival at the plurality of positions; and
successively displaying each weather icon corresponding to each of the plurality of times in the map area.

9. The route-based weather condition display method according to claim 1, further comprising:
obtaining at least one target position on the route, the at least one target position having a weather condition that meets a target condition; and
displaying a corresponding weather bubble at the at least one target position on the route, the weather bubble indicating a weather condition at a corresponding position.

10. The route-based weather condition display method according to claim 1, further comprising:
obtaining at least one target position on the route, the at least one target position having a congestion degree that exceeds a target threshold; and
displaying a corresponding weather bubble at the at least one target position on the route, the weather bubble indicating a weather condition at a corresponding position.

11. The route-based weather condition display method according to claim 1, further comprising:
obtaining at least one target position on the route, the at least one target position having a terrain that meets a target terrain; and
displaying a corresponding weather bubble at the at least one target position on the route, the weather bubble indicating a weather condition at a corresponding position.

12. The route-based weather condition display method according to claim 1, further comprising:
obtaining at least one target position on the route, the at least one target position being configured for providing a service; and
displaying a corresponding weather bubble at the at least one target position on the route, the weather bubble indicating a weather condition at a corresponding position.

13. The route-based weather condition display method according to claim 1, further comprising:
displaying a process line in the electronic map, two ends of the process line respectively corresponding to the start position and the end position, a second slider being displayed on the process line, the second slider corresponding to the first slider; and
displaying, in response to a sliding operation for the second slider based on a plurality of positions the second slider passes through on the process line, that the first slider slides on the route, a position the first slider passes through on the route corresponding to a position the second slider passes through.

14. A route-based weather condition display apparatus, comprising:
at least one memory configured to store computer program code; and
at least one processor configured to read the program code and operate as instructed by the program code, the program code comprising:
determination code configured to cause at least one of the at least one processor to determine, based on a start position and an end position, a route from the start position to the end position in response to a route search operation triggered for an electronic map; and
display code configured to cause at least one of the at least one processor to:
display a target weather icon and the route in the electronic map, the target indicating a weather condition at a waypoint on the route at a current time, and a first slider being displayed on the route;
play a plurality of weather icons in the electronic map in response to a sliding operation for the first slider, the plurality of weather icons indicating weather conditions at waypoints on the route corresponding to positions of the first slider at times when the waypoints are passed through.

15. The route-based weather condition display apparatus according to claim 14, wherein the target weather icon and the route are displayed in a map area of the electronic map, and the plurality of weather icons are played in the map area of the electronic map.

16. The route-based weather condition display apparatus according to claim 14, wherein the display code is further configured to cause at least one of the at least one processor to:
obtain, based on the route, a duration required to pass through the waypoints on the route;
obtain the plurality of weather icons based on the duration and the current time; and
display the target weather icon and the route in the electronic map based on the plurality of weather icons and the route.

17. The route-based weather condition display apparatus according to claim 16, wherein the display code is further configured to cause at least one of the at least one processor to:
obtain a current weather condition mode, the weather condition mode characterizing a type of the weather condition; and
obtain, based on the weather condition mode, the plurality of weather icons of corresponding types within the duration starting from the current time.

18. The route-based weather condition display apparatus according to claim 17, wherein the display code is further configured to cause at least one of the at least one processor to:
obtain a historical weather condition at the waypoint on the route based on the route; and
determine the current weather condition mode based on the historical weather condition at the waypoint on the route.

19. The route-based weather condition display apparatus according to claim 17, wherein a mode selection control is displayed in the electronic map; and
wherein the display code is further configured to cause at least one of the at least one processor to:
display a plurality of weather condition modes in response to a triggering operation for the mode selection control; and
determine, as a current weather condition mode in response to a selection operation for any weather condition mode, a weather condition mode selected through the selection operation.

20. A non-transitory computer-readable storage medium, storing computer code which, when executed by at least one processor, causes the at least one processor to at least:
determine, based on a start position and an end position, a route from the start position to the end position in response to a route search operation triggered for an electronic map;
display a target weather icon and the route in the electronic map, the target weather icon indicating a weather condition at a waypoint on the route at a current time, and a first slider being displayed on the route; and
play a plurality of weather icons in the electronic map in response to a sliding operation for the first slider, the plurality of weather icons indicating weather conditions at waypoints on the route corresponding to positions of the first slider at times when the waypoints are passed through.
